(19) United States
(12) Patent Application Publication
(10) Pub. No.: US 2025/0101227 A1
(43) Pub. Date: Mar. 27, 2025

(54) THERMALLY CONDUCTIVE SILICONE COMPOSITION

(71) Applicant: TAICA CORPORATION, Tokyo (JP)

(72) Inventor: Tomohisa Mizuno, Tokyo (JP)

(73) Assignee: TAICA CORPORATION, Tokyo (JP)

(21) Appl. No.: 18/851,446

(22) PCT Filed: Mar. 17, 2023
(86) PCT No.: PCT/JP2023/010516

§ 371 Date: Sep. 26, 2024

(30) Foreign Application Priority Data
Mar. 31, 2022 (JP) 2022-057768

(51) Int. Cl. C08L 83/04; C08K 3/22

(52) U.S. Cl. CPC C08L 83/04; C08K 3/22; C08K 2003/2227; C08L 2201/08; C08L 2203/20

(57) ABSTRACT

A thermally conductive silicone composition includes a silicone resin component and a thermally conductive filler (C), the silicone resin component comprising an organopolysiloxane (A) having alkenyl groups at least at both ends, an organohydrogenpolysiloxane (B) having at least one hydrogen atom bonded to a silicon atom in one molecule, and a hydrosilylation catalyst (D). The organopolysiloxane (A) is a phenyl-modified organopolysiloxane having at least one phenyl group in a molecule. The organohydrogenpolysiloxane (B) is a phenyl-modified organohydrogenpolysiloxane having at least one phenyl group in a molecule. A blending ratio of the thermally conductive filler (C) is 200 to 1500 parts by weight based on 100 parts by weight of the silicone resin component. A hardness of a cured product of the thermally conductive silicone composition is 70 or less in terms of Asker C hardness (in accordance with JIS K6249).

### TECHNICAL FIELD

The present invention relates mainly to a thermally conductive silicone composition used for a thermally conductive member for suppressing temperature rise of a substrate to be treated, which will be subjected to etching treatment, in a semiconductor etching apparatus, and more particularly to a thermally conductive silicone composition which is used for a thermally conductive member narrowly set between a focus ring installed on the outer peripheral part of a substrate to be treated and a mounting table cooled by a cooling unit or having a cooling mechanism section, and which can obtain stable adhesion even in a low-temperature region.

### BACKGROUND ART

In a semiconductor production process using dry etching, by mounting a substrate to be treated W such as a wafer on a substrate mounting unit 1 in a treatment chamber and irradiating it with plasm or the like, prescribed etching treatment is performed on the substrate to be treated, as shown in FIGS. 1(a) and (b). The substrate mounting unit 1 includes a mounting table 2 (also referred to as a lower electrode unit 2 hereinafter) having a chuck mechanism section 2a for mounting a wafer W and fixing it by an electrostatic chuck system or the like and a support table 2b functioning as a lower electrode, a focus ring 3 (also referred to as an edge ring) arranged on the outer peripheral part of this mounting table 2, and a cooling unit 4. The mounting table 2 is cooled by the cooling unit 4 to adjust the temperatures of the wafer W that is being etched and the focus ring 3 to optimum conditions. There is another constitution wherein the focus ring 3 is arranged on the mounting table 2 with an accessory component different from the thermally conductive member interposed therebetween, but in the present specification, a structure wherein the accessory component is attached to the mounting table is also generally referred to as a mounting table 2.

In the etching treatment of the wafer, the wafer W is mounted on the mounting table 2, thereafter the wafer is fixed by the chuck mechanism section 2a such as an electrostatic chuck while maintaining the interior of the treatment chamber at a prescribed degree of vacuum, then a high-frequency voltage is applied between an upper electrode (not shown), which is installed facing the lower electrode unit 2, and the lower electrode unit 2 to generate plasma inside the treatment chamber, thereby performing etching processing on the surface of the wafer W.

In this plasm etching processing, the focus ring 3 functions to mitigate discontinuities of the plasma in the peripheral edge neighboring region of the wafer W so that the entire surface of the wafer W may be uniformly subjected to plasma treatment. During the etching processing, in order to suppress a rise of the wafer temperature, the wafer W is cooled by adjusting the mounting table 2 to a low temperature, but when the temperature of the peripheral edge part of the wafer W that is in contact with the focus ring 3 increases with temperature rise of the focus ring 3 irradiated with plasma because of transfer of the heat, as compared with the temperature in the central region of the wafer W, the etching characteristics of the peripheral edge part of the wafer W are deteriorated, and for example, problems such as decrease in hole-opening performance (characteristics capable of definitely engraving down to a prescribed depth by etching) and aspect ratio of etching occur.

As a measure to prevent the temperature rise of the focus ring 3, a method of arranging the thermally conductive member 5 between the mounting table 2 and the focus ring 3 to transfer heat of the focus ring 3 to the mounting table 2 through the thermally conductive member 5, as shown in FIGS. 2(a) and (b), has been proposed. For example, in Patent Literature 1, disclosed is a mounting device for a treatment object, wherein a heat transfer medium is intervened between a mounting table and a focus ring, and pressing means for pressing and fixing the focus ring onto the mounting table is provided, and in Patent Literature 2, proposed is a mounting device for a treatment object, having first cooling mechanism in which first electrostatic adsorption means for making a mounting surface adsorb the treatment object with electrostatic force and second electrostatic adsorption means for making an outer peripheral edge part of the mounting surface adsorb a focus ring with electrostatic force larger than that of the first electrostatic adsorption means are provided, a cooling medium path is formed inside the mounting table, and a first cooling medium composed of a fluid is allowed to pass in this cooling medium path to cool the treatment object and the focus ring through the first and the second electrostatic adsorption means, and second cooling mechanism in which a gas supply route is formed inside the mounting table, and a second cooling medium composed of a gas is supplied inside the gas supply route to spray the gas onto the back surface sides of the treatment object and the focus ring, thereby cooling the treatment object and the focus ring. In Patent Literature 3, proposed is a method for improving heat conduction of a focus ring, comprising arranging a heat transfer sheet between a focus ring and a mounting table, vacuumizing the interior of a chamber prior to treatment of a substrate to be treated, thereafter returning the pressure in the chamber to atmospheric pressure or a reduced pressure state, and thereby removing air in a slit between the heat transfer sheet and the mounting surface to make the heat transfer sheet adhered to the mounting surface.

On the other hand, in recent years, capacity enlargement of a semiconductor memory by a multilayer structure has been made as in a three-dimensional structure NAND type flash memory (3D-NAND), and in order to etch wafers more deeply than before, high-powered plasma etching is progressing. As plasma becomes high-powered, the temperatures of the wafer and the focus ring become higher than those in conventional methods due to heat of plasma in the etching processing. On that account, the temperature of the mounting table needs to be set lower in order to enhance cooling capacity of the cooling mechanism for cooling the wafer and the focus ring. Then, for example, in Patent Literature 4, proposed is an etching method having a step of decreasing a surface temperature of a substrate to −40° C. or lower, a step of generating plasma of a gas containing hydrogen and fluorine by high-frequency electric power for plasma generation, and a step of etching the above-mentioned laminated film by the generated plasma.

### CITATION LIST

### Patent Literature

### Patent Literature 1

Japanese Patent Laid-Open No. 2002-16126

### Patent Literature 2

Japanese Patent Laid-Open No. 2002-33376

### Patent Literature 3

Japanese Patent No. 4695606

### Patent Literature 4

Japanese Patent Laid-Open No. 2022-36899

### Patent Literature 5

Japanese Patent No. 26233380

### SUMMARY OF INVENTION

### Technical Problem

However, when the method of arranging a thermally conductive member between the mounting table and the focus ring to transfer heat of the focus ring to the mounting table through the thermally conductive member is applied in such etching processing, the surface of the thermally conductive member that is in contact with the mounting table and its vicinity are hardened because of a decrease in temperature of the mounting table, and adhesion between the mounting table and the thermally conductive member is decreased, so that a risk of occurrence of a problem that thermal resistance is increased to decrease cooling performance of the focus ring is increased.

As a method for improving this problem, application of a thermally conductive member that has flexibility even in a low-temperature region and does not harden easily is effective, and for example, in Patent Literature 5, disclosed is a silicone composition comprising a vinyl group-containing organopolysiloxane having a prescribed functional group, an organohydrogenpolysiloxane containing at least one hydrogen atom bonded to a silicon atom in one molecule, a platinum group metal-based catalyst, and an aluminum oxide powder that is substantially a spherical powder having an average particle diameter of 50 μm or less and has each content of an alkali metal ion and a halogen ion, as extracted in an atmosphere of 121° C., 2 atm, and 100% RH for 20 hours, of 5 ppm or less, the silicone composition forming a silicone gel having a penetration of 20 to 100.

However, when the thermally conductive member is mounted on the mounting table in such an arrangement that part of the thermally conductive member is exposed to plasma environment that is a vacuum and high-temperature environment, radical generation due to plasma exposure advances deterioration of a silicone gel used as the thermally conductive member from the exposed portion, and due to high-powered plasma, this deterioration proceeds more easily. On that account, there is room for improvement in the viewpoint of suppression of deterioration occurring in the plasma environment (vacuum and high-temperature environment), that is, plasma environmental degradation resistance. Accordingly, the present invention solves the above problem with the conventional technology, and it is an object of the present invention to provide a thermally conductive silicone composition that forms a cured product having both flexibility at low temperatures and plasma environmental degradation resistance.

It is a second object of the present invention to provide a thermally conductive member or a thermally conductive member for a semiconductor etching apparatus, which solves the above problem.

### Solution to Problem

In order to solve the above problem, the thermally conductive silicone composition of the present invention is a thermally conductive silicone composition comprising a silicone resin component and a thermally conductive filler (C), the silicone resin component comprising an organopolysiloxane (A) having alkenyl groups at least at both ends, an organohydrogenpolysiloxane (B) having at least one hydrogen atom bonded to a silicon atom in one molecule, and a hydrosilylation catalyst (D), wherein the organopolysiloxane (A) is a phenyl-modified organopolysiloxane having at least one phenyl group in a molecule; the organohydrogenpolysiloxane (B) is a phenyl-modified organohydrogenpolysiloxane having at least one phenyl group in a molecule; a blending ratio of the thermally conductive filler (C) is 200 to 1500 parts by weight based on 100 parts by weight of the silicone resin component; a hardness of a cured product of the thermally conductive silicone composition is 70 or less in terms of Asker C hardness (in accordance with JIS K6249), and a hardness of the cured product, after being heated in an environment of a vacuum degree of 500 Pa (absolute pressure) and 200° C. for 24 hours, is 70 or less in terms of Asker C hardness (in accordance with JIS K6249); a thermal conductivity of the cured product is 0.5 W/m·K or more; and a low-temperature change ratio of a complex elastic modulus, as determined by dividing an absolute value of a difference between a complex elastic modulus of the cured product at 20° C. and a complex elastic modulus thereof at −60° C. by a complex elastic modulus of the cured product at 20° C., is 700% or less.

Since both the organopolysiloxane (A) and the organohydrogenpolysiloxane (B) constituting the silicone resin component have a phenyl-modified structure, the solidification point can be eliminated, flexibility of a cured product at low temperatures can be maintained, and the radical resistance is excellent, so that plasma environmental degradation resistance can be enhanced. Moreover, an uncrosslinked component capable of bleeding, such as free oil, is stably trapped in the vicinity of the crosslinked gel structure by virtue of stacking action of a phenyl group of each compound, and therefore, working-effect of suppressing bleed of the uncrosslinked component from the cured product is also obtained. The blending quantity of the thermally conductive filler (C) is set to 200 to 1500 parts by weight based on 100 parts by weight of the silicone resin component, and in addition, a hardness of a cured product of the thermally conductive silicone composition is set to 70 or less in terms of Asker C hardness (in accordance with JIS K6249), a hardness of the cured product, after being heated in an environment of a vacuum degree of 500 Pa (absolute pressure) and 200° C. for 24 hours, is set to 70 or less in terms of Asker C hardness (in accordance with JIS K6249), and a thermal conductivity of the cured product is set to 0.5 W/m·K or more, and thereby the thermally conductive silicone composition has appropriate thermal conductive properties, a cured product thereof has small change in hardness even if it is exposed to plasma environment (vacuum and high-temperature environment), and adhesion to a surface of an adherend in an environment of low temperatures to ordinary temperature is obtained.

Furthermore, since the low-temperature change ratio of a complex elastic modulus, as determined by dividing an absolute value of a difference between a complex elastic modulus of the cured product at 20° C. and a complex elastic modulus thereof at −60° C. by a complex elastic modulus of the cured product at 20° C., is 700% or less, flexibility of the cured product is maintained even when the cured product is used in a low-temperature environment, and an increase in hardness (hardening) in an environment with rapid temperature changes from a low temperature to a high temperature hardly occurs, so that adhesion to a surface of an adherend such as a mounting table is maintained, and temperature rise of a heat dissipation target such as a focus ring can be stably suppressed.

A hardness of the silicone resin component constituting the thermally conductive silicone composition of the present invention, after crosslinking reaction, is preferably 110 or less in terms of consistency (in accordance with JIS K2220 ¼ cone). Due to this, the cured product has excellent shape retention properties, and in addition, even when the cured product is used in a low-temperature environment, flexibility is maintained, and an effect of hardly causing an increase in hardness (hardening) in an environment with rapid temperature changes from a low temperature to a high temperature is optimized.

The thermally conductive silicone composition of the present invention also preferably further comprises a heat stabilizer (E). Due to this, hardness change of the cured product caused by thermal deterioration in a high-temperature environment such as a plasma etching environment can be suppressed.

In the thermally conductive silicone composition of the present invention having constitution containing a heat stabilizer (E), a blending ratio of the heat stabilizer (E) is also preferably 0.1 to 20 parts by weight based on 100 parts by weight of the silicone resin component. Due to this, hardness change of the cured product caused by thermal deterioration in a high-temperature environment such as a plasma etching environment can be more effectively suppressed, and therefore, plasma environmental degradation resistance can be more enhanced.

In the thermally conductive silicone composition of the present invention having constitution containing a heat stabilizer (E), the heat stabilizer (E) is also preferably a metal oxide or a carbon-based heat stabilizer, which has radical trapping properties. Due to this, radical resistance of the thermally conductive silicon composition can be enhanced to further enhance plasma environmental degradation resistance of a cured product, and in addition, oil bleed can be reduced.

The thermally conductive member and the thermally conductive member for a semiconductor etching apparatus of the present invention each comprise a cured product of the above-mentioned thermally conductive silicone composition. They have both flexibility at low temperatures and plasma environmental degradation resistance, and therefore, even when high-powered plasm is used in the semiconductor etching processing, temperature rise of a focus ring can be suppressed stably over time.

### Advantageous Effects of Invention

The thermally conductive silicone composition of the present invention comprises components of an organopolysiloxane (A) having alkenyl groups at least at both ends, an organohydrogenpolysiloxane (B) having at least one hydrogen atom bonded to a silicon atom in one molecule, a thermally conductive filler (C), and a hydrosilylation catalyst (D); at least one phenyl group is introduced in each molecule of the organopolysiloxane (A) and the organohydrogenpolysiloxane (B); a hardness after crosslinking reaction of the organopolysiloxane (A) with the organohydrogenpolysiloxane (B), and a blending ratio of the thermally conductive filler (C) based on the total of the organopolysiloxane (A), the organohydrogenpolysiloxane (B) and the hydrosilylation catalyst (D) are set in specific ranges; and the cured product has prescribed physical properties; and therefore, the cured product has both flexibility at low temperatures and plasma environmental degradation resistance. Moreover, since the thermally conductive silicon composition has constitution containing a heat stabilizer (E), the cured product has flexibility at low temperatures and plasma environmental degradation resistance, and in addition, the thermally conductive silicone composition can have excellent low-oil bleed properties. Furthermore, the thermally conductive member composed of a cured product of the thermally conductive silicone composition of the present invention has low-oil bleed properties in addition to flexibility at low temperatures and plasma environmental degradation resistance, and therefore, even when the thermally conductive member is used in contact with a mounting table in a low-temperature state in the case of using high-powered plasma in the semiconductor etching processing, it has excellent flexibility at low temperatures, and hardening hardly occurs even in an environment with rapid temperature changes from a low temperature to a high temperature caused by plasma etching. Due to this, adhesion to a mounting table or a focus ring is secured, and temperature rise of the focus ring can be suppressed stably over time, so that quality and productivity of semiconductors can be enhanced by virtue of uniform etching processing on the whole surface of wafer and reduction of maintenance frequency.

### BRIEF DESCRIPTION OF DRAWINGS

FIG. 1 is a group of sectional views showing an example of a structure of a plasma etching apparatus.

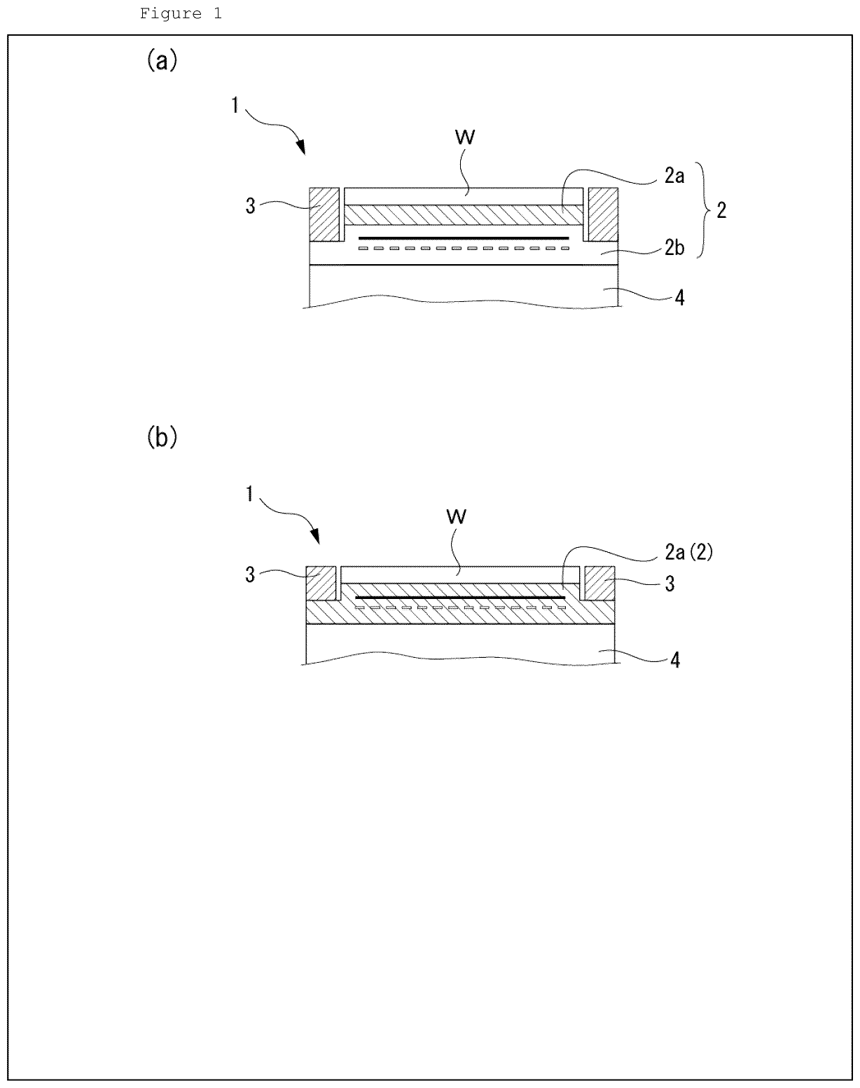

FIG. 2 is a group of sectional views showing an example of a structure in which a thermally conductive member is arranged in a plasma etching apparatus and an embodiment of a thermally conductive member for a semiconductor etching apparatus according to the present invention.

### DESCRIPTION OF EMBODIMENTS

The thermally conductive silicone composition according to the present invention is a thermally conductive silicone composition comprising a silicone resin component and a thermally conductive filler (C), the silicone resin component comprising an organopolysiloxane (A) having alkenyl groups at least at both ends, an organohydrogenpolysiloxane (B) having at least one hydrogen atom bonded to a silicon atom in one molecule, and a hydrosilylation catalyst (D), wherein the organopolysiloxane (A) is a phenyl-modified organopolysiloxane having at least one phenyl group in a molecule; the organohydrogenpolysiloxane (B) is a phenyl-modified organohydrogenpolysiloxane having at least one phenyl group in a molecule; a blending ratio of the thermally conductive filler (C) is 200 to 1500 parts by weight based on 100 parts by weight of the silicone resin component; a hardness of a cured product of the composition is 70 or less in terms of Asker C hardness (in accordance with JIS K6249), and a hardness of the cured product, after being heated in an environment of a vacuum degree of 500 Pa (absolute pressure) and 200° C. for 24 hours, is 70 or less in terms of Asker C hardness (in accordance with JIS K6249); a thermal conductivity of the cured product is 0.5 W/m·K or more; and a low-temperature change ratio of a complex elastic modulus, as determined by dividing an absolute value of a difference between a complex elastic modulus of the cured product at 20° C. and a complex elastic modulus thereof at −60° C. by a complex elastic modulus of the cured product at 20° C., is 700% or less. Hereinafter, the thermally conductive silicone composition will be described in detail.

### (Silicone Resin Component)

The silicone resin component constituting the thermally conductive silicone composition of the present invention contains an organopolysiloxane (A) having alkenyl groups at least at both ends, an organohydrogenpolysiloxane (B) having at least one hydrogen atom bonded to a silicon atom in one molecule, and a hydrosilylation catalyst (D), and the (A) component and the (B) component undergo crosslinking reaction to cure the silicone resin component.

### (Organopolysiloxane (A))

The organopolysiloxane (A) constituting the silicone resin component is an organopolysiloxane having alkenyl groups at least at both ends, and is a component that undergoes crosslinking reaction with an organohydrogenpolysiloxane (B) described later to form a cured product and becomes a main skeleton of the silicone resin component. The organopolysiloxane (A) is a phenyl-modified organopolysiloxane having at least one phenyl group in a molecule, and by the structure having a phenyl group in a molecule, flexibility can be maintained even at low temperatures, and in addition, during curing due to the crosslinking reaction, unreacted free oil is stably trapped in the vicinity of the crosslinked gel structure by the stacking action of a phenyl group, and therefore, working-effect of suppressing oil bleed is also obtained. Furthermore, since the organopolysiloxane (A) has been modified with phenyl, radical resistance of the silicone resin component is enhanced, and therefore, alteration and deterioration of the thermally conductive silicone composition caused by plasma hardly occur, and plasma environmental degradation resistance can be enhanced. To an example of the phenyl-modified organopolysiloxane, one represented by the following general formula (1) can be applied.

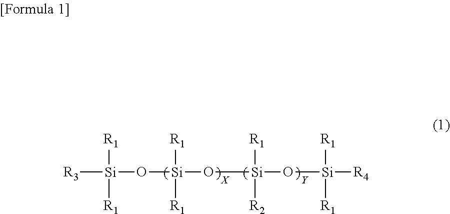

Here, in the formula (1), each R1 represents the same or different, substituted or unsubstituted monovalent hydrocarbon group, R2 represents a phenyl group, R3 and R4 each represent an alkenyl group, x and y are each an integer indicating the number of units, and the units are arranged in block or at random, preferably at random. Examples of R1 include alkyl groups, such as a methyl group, an ethyl group, a propyl group, and a butyl group, cycloalkyl groups, such as a cyclopentyl group and a cyclohexyl group, aryl groups, such as a phenyl group and a tolyl group, aralkyl groups, such as a benzyl group and a phenylethyl group, and halogenated hydrocarbons wherein hydrogen atoms of these groups are partially substituted by a chlorine atom, a fluorine atom, and the like. Examples of R3 and R4 include a vinyl group, an allyl group, a butenyl group, a pentenyl group, and a hexenyl group. From the viewpoint of availability of material, R3 and R4 are each preferably a vinyl group. A content and a bonding position of a phenyl group bonded to a silicon atom of a polysiloxane chain are appropriately set withing ranges in which the effects of the present invention are obtained. For example, a phenyl group content (mol % based on the total of monovalent organic groups (unsubstituted or substituted monovalent hydrocarbon groups) bonded to silicone atoms in the organopolysiloxane) is preferably 15 mol % or less, more preferably 10 mol % or less, from the viewpoint of a balance between plasma environmental degradation resistance and flexibility under the low-temperature conditions. Regarding the bonding position of a phenyl group, a phenyl group is preferably bonded to a silicon atom of D unit (SiO unit) from the viewpoint of flexibility under the low-temperature conditions.

### (Organohydrogenpolysiloxane (B))

The organohydrogenpolysiloxane (B) constituting the silicone resin component is an organohydrogenpolysiloxane having at least one hydrogen atom bonded to a silicon atom in one molecule (also referred to as a SiH group hereinafter), and is a component that undergoes crosslinking reaction with an alkenyl group of the above-mentioned organopolysiloxane (A) and acts as a crosslinking agent for curing the thermally conductive silicone composition. The organohydrogenpolysiloxane (B) is a phenyl-modified organohydrogenpolysiloxane having at least one phenyl group in a molecule, and due to the structure having a phenyl group in a molecule, it has an action similar to that of the phenyl group of the organopolysiloxane (A), so that it contributes also to more low-temperature flexibility and low-oil bleed properties in cooperation with the action of the phenyl group of the organopolysiloxane (A). Furthermore, since the organohydrogenpolysiloxane (B) also has been modified with phenyl, radical resistance of the silicone resin component is enhanced, and therefore, plasma environmental degradation resistance of the thermally conductive silicone composition can be enhanced. To an example of the phenyl-modified organohydrogenpolysiloxane, one represented by the following general formula (2) can be applied.

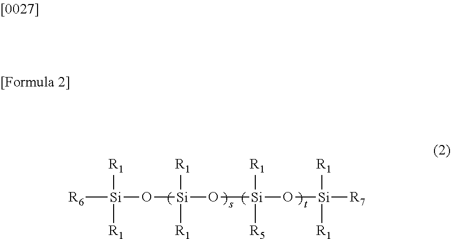

Here, in the formula (2), each R1 represents the same or different, substituted or unsubstituted monovalent hydrocarbon group, R5, R6, and R7 each represent R1 or a phenyl group or —H, at least two of R5, R6, and R7 each represent —H, s and t are each an integer indicating the number of units, and the units are arranged in block or at random, preferably at random. Examples of R1 include alkyl groups, such as a methyl group, an ethyl group, a propyl group, and a butyl group, cycloalkyl groups, such as a cyclopentyl group and a cyclohexyl group, aryl groups, such as a phenyl group and a tolyl group, aralkyl groups, such as a benzyl group and a phenylethyl group, and halogenated hydrocarbons wherein hydrogen atoms of these groups are partially substituted by a chlorine atom, a fluorine atom, and the like. A content and a bonding position of a phenyl group bonded to a silicon atom of a polysiloxane chain are appropriately set within ranges in which the effects of the present invention are obtained. For example, a phenyl group content (mol % based on the total of monovalent organic groups (unsubstituted or substituted monovalent hydrocarbon groups) bonded to silicone atoms in the organopolysiloxane) is preferably 15 mol % or less, more preferably 10 mol % or less, from the viewpoint of a balance between plasma environmental degradation resistance and flexibility under the low-temperature conditions. Regarding the bonding position of a phenyl group, a phenyl group is preferably bonded to a silicon atom of D unit (SiO unit) from the viewpoint of flexibility under the low-temperature conditions.

(Hydrosilylation catalyst (D))

The hydrosilylation catalyst (D) constituting the silicone resin component is a component that accelerates hydrosilylation reaction of the alkenyl group in the above-mentioned organopolysiloxane (A) with the SiH group in the organohydrogenpolysiloxane (B) to crosslink and cure the silicone resin component. The hydrosilylation catalyst (D) is not particularly limited as long as it accelerates the above-mentioned crosslinking reaction, and a known one can be appropriately selected and applied, and examples thereof include platinum-based, palladium-based, and rhodium-based catalysts. Among these, platinum or a platinum compound, which is relatively obtainable, is preferable, and in more detail, examples thereof include elemental platinum, platinum black, chloroplatinic acid, a platinum-olefin complex, a platinum-alcohol complex, and a platinum coordination compound. The platinum-based catalysts may be used singly or in combination of two or more.

A content of the hydrosilylation catalyst (D) may be an catalytic amount enough to accelerate the crosslinking reaction of the organopolysiloxane (A) with the organohydrogenpolysiloxane (B) and is not particularly restricted, but it is preferably 0.1 to 500 ppm, more preferably 1.0 to 100 ppm, by mass unit, in terms of an amount of metal atoms in the hydrosilylation catalyst (D), based on the total weight of the organopolysiloxane (A) and the organohydrogenpolysiloxane (B). If the content of the hydrosilylation catalyst (D) is less than 1.0 ppm, an effect of a catalyst may not be obtained, and if it exceeds 100 ppm, a catalytic effect is saturated, so that there is no benefit from the viewpoint of raw material cost.

From the viewpoint of shape retention properties of a cured product of the thermally conductive silicone composition of the present invention, blending ratios of the organopolysiloxane (A), the organohydrogenpolysiloxane (B), and the hydrosilylation catalyst (D) constituting the silicone resin component are preferably set so that the hardness of the silicone resin component after crosslinking reaction may become 110 or less in terms of consistency (in accordance with JIS K2220 ¼ cone). If the consistency exceeds 110, insufficient curing may occur, or oil bleed sometimes tends to occur. In order to set the hardness range of the silicone resin component to the above-mentioned range, a ratio of the number of hydrogen atoms bonded to silicon atoms of the organohydrogenpolysiloxane (B) to the number of alkenyl groups of the organopolysiloxane (A) is adjusted to 0.5 to 2. A phenyl group content (mol % based on the total of monovalent organic groups (unsubstituted or substituted monovalent hydrocarbon groups) bonded to silicone atoms in the organopolysiloxane) in the silicone resin component is preferably 15 mol % or less, more preferably 10 mol % or less, from the viewpoint of a balance between plasma environmental degradation resistance and flexibility under the low-temperature conditions. The phenyl group content in the silicone resin component can be adjusted by the contents of phenyl groups in the organopolysiloxane (A) and the organohydrogenpolysiloxane (B) and the blending ratio between both components.

The organopolysiloxane (A) and the organohydrogenpolysiloxane (B) constituting the silicone resin component may be each constituted of a combination of a plurality of components. Moreover, a polysiloxane component functioning as a chain extender for connecting a plurality of polymer main chains of the organopolysiloxane (A) may be contained.

### (Thermally Conductive Filler (C))

The thermally conductive filler (C) constituting the thermally conductive silicone composition of the present invention is a component that imparts thermal conductive properties to the thermally conductive silicone composition, and a known thermally conductive filler can be applied. As a specific example, a thermally conductive filler composed of at least one material selected from the group consisting of a metal, a metal oxide, a metal hydroxide, a metal nitride, a metal carbide, and an allotrope of carbon is preferable, and in use in a plasma etching environment, alumina, zinc oxide, magnesium oxide, aluminum nitride, boron nitride, and silicon carbide, which have a low dielectric constant and good heat resistance, are more preferable. The shape of the thermally conductive filler (C) may be any of spherical, amorphous, needle-like, etc., and is not particularly limited. From the viewpoint of improvement in dispersibility in the silicone resin component, a substance obtained by coating the surface of the thermally conductive filler (C) with a surface treatment agent may be used. As the surface treatment agent, a known one such as a silane coupling agent can be appropriately selected and applied.

From the viewpoint that the thermally conductive silicone composition has a viscosity for good processability when uncured while improving a filling factor of the thermally conductive filler (C) in the thermally conductive silicone composition, the thermally conductive filler (C) is preferably composed of a combination of a large particle size component and a small particle size component. The large particle size component has an average particle diameter of 10 to 120 μm, preferably 15 to 100 μm, and the small particle size component has an average particle diameter of 0.01 to 10 μm, preferably 0.1 to 4 μm. A mixing ratio between the large particle size component and the small particle size component is appropriately set according to design of a filling factor in the thermally conductive silicone composition and a viscosity when uncured. The average particle diameter of the thermally conductive filler (C) in the present invention can be determined as a mass average value (median diameter) in the particle size distribution measurement through laser light diffractometry.

From the viewpoint of good thermal conductive properties required for the thermally conductive silicone composition and flexibility of a cured product thereof, the blending quantity of the thermally conductive filler (C) is 200 to 1500 parts by weight, more preferably 200 to 1200 parts by weight, based on 100 parts by weight of the silicone resin component. If the blending quantity of the thermally conductive filler (C) is less than 200 parts by weight, sufficient thermal conductive properties are not obtained, and if the quantity thereof exceeds 1500 parts by weight, flexibility after curing, which is required for the thermally conductive silicone composition for a semiconductor etching apparatus, is not obtained.

### (Heat Stabilizer (E))

The thermally conductive silicone composition of the present invention preferably further contains a heat stabilizer (E). The heat stabilizer (E) is a component that not only imparts heat resistance and plasma environmental degradation resistance to a cured product of the thermally conductive silicone composition but also can impart an action of reducing occurrence of oil bleed. Specific examples of the heat stabilizers (E) that can be used include known ones, such as iron oxide, carbon-based materials, e.g., carbon black, graphite, carbon nanotube, and carbon fiber, iron carboxylate, cesium hydrate, titania, barium zirconate, cerium octanoate, zirconium octanoate, and porphyrin, but preferable is a heat stabilizer of carbon-based material, which does not act as an oxidizing agent particularly in a vacuum and heating environment and is excellent in radical trapping properties. The heat stabilizers may be used singly or in combination of a plurality of types.

A blending ratio of the heat stabilizer (E) is 0.1 to 20 parts by weight, more preferably 0.1 to 10 parts by weight, particularly preferably 0.1 to 5 parts by weight, based on 100 parts by weight of the silicone resin component. If the blending ratio of the heat stabilizer (E) is less than 0.1 part by weight, a heat stabilization effect in a cured product of the thermally conductive silicone composition may not be obtained sufficiently, and if it exceeds 20 parts by weight, problems of decrease in thermal conductive properties and poor dispersion of the heat stabilizer in the thermally conductive silicone composition sometimes occur.

### (Other Components)

The thermally conductive silicone composition of the present invention may contain other components as long as the objects of the present invention are not impaired, and for example, various additives for imparting functions, such as a dispersant to improve dispersibility of the thermally conductive filler (C) in the silicone resin component, a reaction inhibitor to adjust a curing rate, a pigment and a dye for coloring, a flame retardancy imparting agent, and an internal mold release agent to improve mold release from a mold or a separator film, can be added.

### (Method for Producing Thermally Conductive Silicone Composition)

Regarding the thermally conductive silicone composition of the present invention, an uncured thermally conductive silicone composition is easily prepared by blending the (A) to (D) components mentioned above or the (A) to (E) components mentioned above, and a filling material and other various components that are added as needed in prescribed ratios and homogenously mixing them. The mixing means is not particularly limited, and known mixers, kneaders, or the like can be applied. The uncured thermally conductive silicone composition can be cured by allowing the composition to stand at ordinary temperature or heating it to accelerate crosslinking reaction.

### (Cured Product of Thermally Conductive Silicone Composition)

A cured product of the thermally conductive silicone composition of the present invention has physical properties: a hardness at ordinary temperature is 70 or less in terms of Asker C hardness (in accordance with JIS K6249), and a hardness, after being heated in an environment of a vacuum degree of 500 Pa (absolute pressure) and 200° C. for 24 hours, is 70 or less in terms of Asker C hardness (in accordance with JIS K6249); a thermal conductivity after curing is 0.5 W/m·K or more; and a low-temperature change ratio of a complex elastic modulus, as determined by dividing an absolute value of a difference between a complex elastic modulus at 20° C. after curing and a complex elastic modulus at −60° C. after curing by a complex elastic modulus at 20° C., is 700% or less. Due to this, a cured product having flexibility at low temperatures, plasma environmental degradation resistance, and excellent thermal conductive properties is obtained.

If the hardness of a cured product of the thermally conductive silicone composition of the present invention exceeds 70 in terms of Asker C hardness, followability to the shape or surface irregularities of an adherend such as a mounting table or a focus ring in a semiconductor etching apparatus is deteriorated, good adhesion is not obtained, and a problem of an increase in thermal resistance on the contact interface occurs. The hardness of the cured product is preferably 20 to 60 in terms of Asker C hardness from the viewpoint of adhesion to an adherend such as a mounting table or a focus ring and handleability due to moderate softness. The reason why the hardness in terms of Asker C hardness is preferably 20 or more is that if the Asker C hardness is less than 20, a cured product of the thermally conductive silicone composition is so soft that the handleability is sometimes decreased.

Regarding the cured product of the thermally conductive silicone composition, if the hardness of the cured product after being heated in an environment of a vacuum degree of 500 Pa (absolute pressure) and 200° C. for 24 hours exceeds 70 in terms of Asker C hardness (in accordance with JIS K6249), a decrease in flexibility of the cured product due to heat stress generated by exposure of the cured product to plasma environment (vacuum and high temperature environment) or due to contact with plasma tends to proceed, and when the cured product is used for a semiconductor etching apparatus, adhesion to an adherend such as a mounting table or a focus ring is decreased to deteriorate cooling performance of the focus ring.

If the thermal conductivity of the cured product is less than 0.5 W/m·K, cooling performance of a heat dissipation target such as a focus ring becomes insufficient. The thermal conductivity in the present invention is a value that is measured as a thermal conductivity in the thickness direction of a sheet of length 10 mm×width 10 mm×thickness 2.0 mm serving as a specimen by a steady state method in accordance with ASTM D5470 under the condition that a load of 5 N is applied all over the specimen and an average value of temperatures on the heating side and the cooling side becomes 50° C.

By setting a low-temperature change ratio of a complex elastic modulus, as determined by dividing an absolute value of a difference between a complex elastic modulus of the cured product at 20° C. and a complex elastic modulus thereof at −60° C. by a complex elastic modulus of the cured product at 20° C., to 700% or less, flexibility at low temperatures is excellent, and an increase in hardness (hardening) in an environment with rapid temperature changes from a low temperature to a high temperature hardly occurs, so that adhesion to an adherend such as a mounting table or a focus ring is maintained. Due to this, a decrease in thermal conductive properties is prevented, and stable etching processing can be carried out. Here, the complex elastic modulus is a measured value in torsional shear mode at 10 Hz.

### (Thermally Conductive Member)

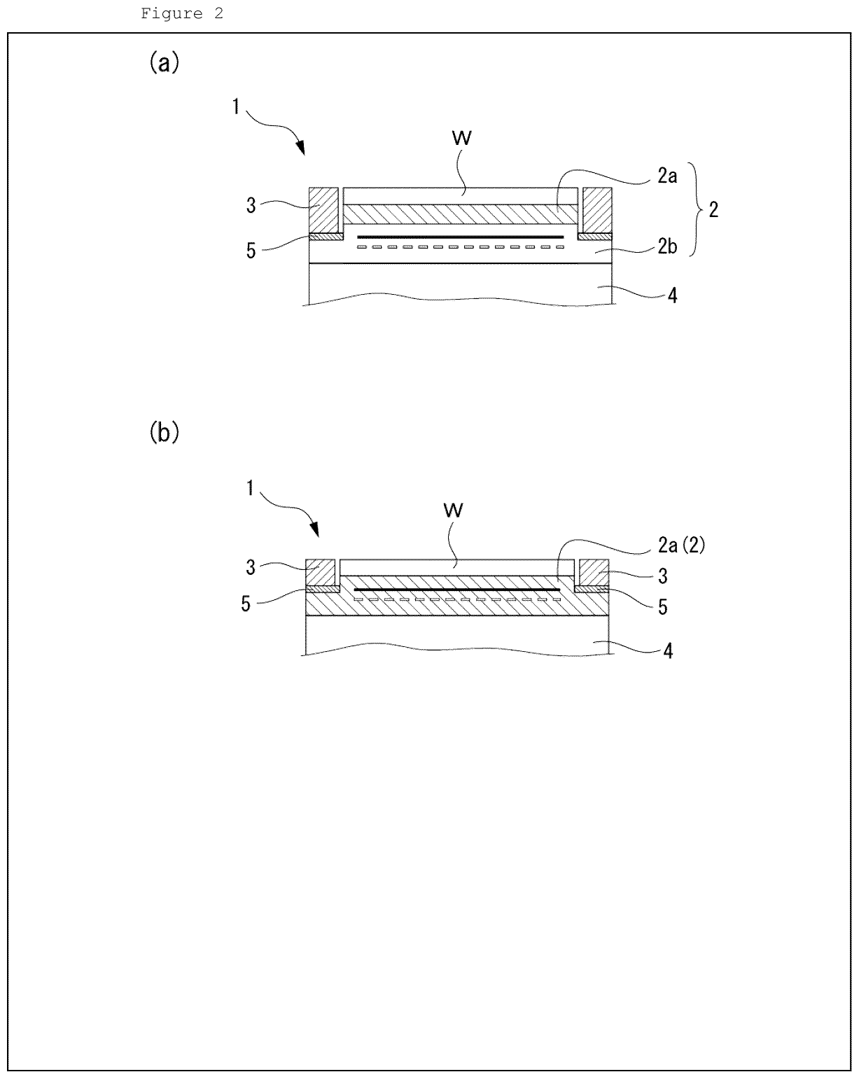

The thermally conductive member of the present invention is a cured product of the thermally conductive silicone composition of the present invention and is obtained by molding and curing an uncured thermally conductive silicone composition. The thermally conductive member is arranged in contact with or close to a heat dissipation target or a heat absorption target, and is used so as to propagate heat from the target to another member or into the environment. Since the thermally conductive member is excellent in flexibility at low temperatures and plasma environmental degradation resistance, it is preferably used particularly as a thermally conductive member for a semiconductor etching apparatus. As shown in FIGS. 2(a) and (b), the thermally conductive member 5 for a semiconductor etching apparatus is used by being arranged so as to form a heat conduction path between a focus ring 3 and a mounting table 2 that constitute a substrate mounting unit 1 of the semiconductor etching apparatus. The thickness and the shape of the thermally conductive member 5 can be appropriately set according to the shapes and arrangement of the focus ring 3 and the mounting table 2, but in order to reduce thermal resistance in the thickness direction, the thermally conductive member is preferably in the form of a thin sheet. When the thermally conductive member is a thin sheet, the thickness thereof is preferably 10 μm to 10 mm, more preferably 100 μm to 1 mm, still more preferably 200 to 500 μm. In a method for producing the thermally conductive member, an uncured thermally conductive silicone composition is molded into a prescribed shape, and this molded product is allowed to stand at ordinary temperature or heated, thereby obtaining the thermally conductive member. For example, when the thermally conductive member is in the form of a sheet, an uncured composition is supplied onto a base film, then molded into a sheet form by a known method such as calendaring, and cured by heating, and thereafter, this sheet-like cured product is subjected to a known method, such as die cutting, laser processing, or plotter processing, to obtain a thermally conductive member having a prescribed shape.

The surface of the thermally conductive member of the present invention may be tacky or non-tacky. When the surface of the thermally conductive member has tackiness, a tack thereof is preferably No. 4 or more in terms of a value of an inclined ball tack test (in accordance with JIS Z0237) at an inclination angle of 30°, and from the viewpoint of securing adhesion to an adherend such as a mounting table or a focus ring to suppress an increase in thermal resistance, the value is still more preferably No. 6 or more. When the thermally conductive member is used for a semiconductor etching apparatus, a value of an inclined ball tack test, after a heat cycle test of 1,000 cycles on condition that an operation of holding the thermally conductive member at −60° C. for 30 minutes and then holding it at 200° C. for 30 minutes is 1 cycle, is preferably No. 4 or more, from the viewpoint of reliability during plasma etching processing. In a combination of a focus ring and a mounting table as one example of a combination of adherends, a surface of the thermally conductive member that comes into contact with the focus ring and a surface thereof that comes into contact with the mounting table may differ in tack from the viewpoint of attachment-detachment workability to or from the focus ring and the mounting table, and a difference in ball number between the above surfaces in the above-mentioned inclined ball tack test is preferably 2 to 12. For imparting tackiness to the surface of the thermally conductive member, a known method, such as a method of adding a tackifier to the thermally conductive silicone composition to make the surface tacky or a method of applying an adhesive coating onto the surface of the thermally conductive member, can be applied. When the surface of the thermally conductive member is made non-tacky, a known method, such as a method of applying a non-adhesive thermally conductive silicone composition or a method of applying a non-adhesive coating onto the surface of the thermally conductive member or performing surface modification such as excimer treatment or plasma treatment thereon, can be applied.

### EXAMPLES

Hereinafter, the present invention will be specifically described with reference to Examples, but the present invention is not particularly limited to these Examples.

Methods for measuring physical properties and methods for evaluating the effects in the following Examples and Comparative Examples are as follows.

### (1) Thermal Conductivity (Thermal Conductive Properties)

An uncured thermally conductive silicone composition in each of Examples and Comparative Examples was calendered into a sheet having a thickness of 2.0 mm, then the sheet was preheated at 70° C. for 1 hour in a hot air oven (WFO-520W manufactured by TOKYO RIKAKIKAI CO., LTD.), and thereafter the sheet was heated at 100° C. for 3 hours to obtain a sheet-like cured product of the thermally conductive silicone composition having a thickness of 2.0 mm. This was die-cut into a sheet-like specimen of 10 mm×10 mm, then by a steady state method in accordance with ASTM D5470, a load of 5 N was applied all over the specimen, and a thermal conductivity in the thickness direction was measured under the condition that an average value of temperatures on the heating side and the cooling side became 50° C. As the measuring device, a resin material thermal resistance measuring device (manufactured by Hitachi Technologies and Services, Ltd.) was used. In the evaluation of thermal conductive properties, a case where an average value of thermal conductivities of three specimens was 0.5 W/m·K or more was evaluated as pass (Excellent), and a case where the average value is less than 0.5 W/m·K was evaluated as fail (Poor).

### (2) Hardness of Cured Product at Ordinary Temperature (Ordinary Temperature Flexibility)

An uncured thermally conductive silicone composition in each of Examples and Comparative Examples was molded into a molded product of length 60 mm×width 60 mm×thickness 12 mm, and the molded product was preheated at 70° C. for 1 hour, then heated at 100° C. for 3 hours and cured to prepare a specimen. Using an Asker C durometer (SRIS 0101 standard, “Askar Rubber Hardness Tester C type” manufactured by KOUBUNSHI KEIKI CO., LTD.) in accordance with JIS K6253, the specimen composed of a cured product of the thermally conductive silicone composition was subjected to hardness measurement at ordinary temperature. In the evaluation of ordinary temperature flexibility, a case where the Asker C hardness was 20 to 60 was evaluated as excellent (Excellent), a case where the Asker C hardness was less than 20, or more than 60 and 70 or less was evaluated as good (Good), and a case where the Asker C hardness exceeds 70 was evaluated as fail (Poor).

(3) Hardness of Cured Product after Vacuum Heat Treatment (Plasma Environmental Degradation Resistance)

The specimen (initial hardness H0) having been subjected to measurement of (2) Asker C hardness at ordinary temperature mentioned above was heated and allowed to stand for 24 hours in a vacuum oven under the condition of a vacuum degree (absolute pressure) of 500 Pa and 200° C. Subsequently, the specimen was allowed to stand at room temperature 23±2° C. for 3 hours to adjust the temperature of the specimen to room temperature, and Asker C hardness (H1) of the specimen after vacuum heat treatment was measured in accordance with a measuring method for (2) Asker C hardness. In the evaluation of the plasma environmental degradation resistance, a case where the Asker C hardness (H1) of the specimen after vacuum heat treatment was 70 or less was evaluated as pass, and a case where the Asker C hardness (H1) exceeded 70 was evaluated as fail (Poor). Further, regarding the pass judgement, a ratio of an amount of hardness change before or after the vacuum heat treatment to the initial hardness H0, (H1−H0), was regarded as a hardness change ratio (%), and a case where the hardness change ratio was 50% or less was judged as excellent (Excellent), a case where the hardness change ratio was more than 50% and 100% or less was judged as good (Good), and a case where the hardness change ratio exceeded 100% was judged as fair (Fair). When the initial hardness H0 is in the soft region in which Asker C hardness is 1 or less, the hardness change ratio is calculated to be large even in the case of an amount of hardness change that exerts small influence on the effects of the present invention, so that evaluation was made based on the amount of hardness change, and a case where the amount of hardness change was 5 or less was judged as excellent (Excellent), a case where the amount of hardness change was more than 5 to 10 was judged as good (Good), and a case where the amount of hardness change exceeded 10 was judged as fair (Fair).

### (4) Change Ratio of Complex Elastic Modulus at Low Temperatures (Low-Temperature Flexibility)

An uncured thermally conductive silicone composition in each of Examples and Comparative Examples was calendered into a sheet having a thickness of 2 mm, then the sheet was preheated at 70° C. for 1 hour in a hot air oven (WFO-520W manufactured by TOKYO RIKAKIKAI CO., LTD.), and thereafter the sheet was heated at 100° C. for 3 hours to obtain a sheet-like cured product of the thermally conductive silicone composition having a thickness of 2.0 mm. This was die-cut to 8 mm diameter to prepare a disk-shaped specimen of 8 mm diameter×2 mm thickness, and using a dynamic mechanical analyzer (ARES-G2; TA Instruments Inc. product), a complex elastic modulus at 10 Hz was measured in the range of 20° C. to −60° C. A value, as obtained by dividing an absolute value of a difference between a complex elastic modulus of each specimen at −60° C. (G*1) and a complex elastic modulus thereof at 20° C. (G*0), (IG*1−G*0|), by a complex elastic modulus thereof at 20° C. (G*0), (IG*1−G*0|/G*0), was calculated as a change ratio (%). In the evaluation of low-temperature flexibility, a case where the change ratio was 700% or less was judged as good (Good), and a case where the change ratio exceeded 700% was judged as poor (Poor).

### (5) Oil Bleed Properties

A disk-shaped specimen of 8 mm diameter×2 mm thickness made in the same manner as in the test method of (4) mentioned above was prepared, and it was directly placed on a frosted glass plate (manufactured by Kowa Co., Ltd., frosted glass, Ra=2.4 μm) so that all the bottom surface of the specimen might come into contact with the glass plate. This was allowed to stand in an oven for 24 hours under the condition of 200° C., then a maximum diameter (L1) of portions of the frosted glass surface which had been discolored by oil bleed was measured, and occurrence of oil bleed was observed.

(6) Consistency of Silicone Resin Component after Curing

A PP resin container (manufactured by AS ONE CORPORATION, disposal cup 100 ml) was filled with an uncured silicone resin component used in each of Examples and Comparative Example so that the thickness might become 30 mm, the surface of the resin component was made almost flat, and then vacuum degassing was performed. Thereafter, the resin component with the container was preheated at 70° C. for 1 hour in a hot air oven (WFO-520W manufactured by TOKYO RIKAKIKAI CO., LTD.) and then heated at 100° C. for 3 hours to allow the organopolysiloxane (A) and the organohydrogenpolysiloxane (B) in the silicone resin component to undergo crosslinking reaction and thereby cure the silicone resin component, and it was allowed to stand in an environment where the temperature of the cured product became 25° C. In a state where this cured product was contained in the container, a consistency of the silicone resin component after curing was measured in accordance with JIS K2220 ¼ cone.

### Example 1

Using a two-component addition reaction type silicone gel (I) (SEMICOSIL (registered trademark) 920LT manufactured by Wacker Asahikasei Silicone Co., Ltd.) as a silicone resin component, A liquid in which a phenyl-modified organopolysiloxane having vinyl groups at both ends, as an organopolysiloxane (A) component, and a hydrosilylation catalyst (D) had been mixed, and B liquid in which the organopolysiloxane (A) component and a phenyl modified organohydrogenpolysiloxane as an organohydrogenpolysiloxane (B) component had been mixed were blended at a weight ratio of 55:45 to prepare 100 g of a silicone resin component. When measurement of (6) Consistency after curing mentioned above was carried out for this silicone resin component, the consistency was 58.9. On the other hand, as a thermally conductive filler (C), 500 g of an aluminum oxide powder of three-component system consisting of 300 g of a first aluminum oxide powder (manufactured by Denka Company Limited, DAW-70, average particle diameter 70 μm), 150 g of a second aluminum oxide powder (manufactured by Showa Denko K.K., CB-P05, average particle diameter 5 μm), and 50 g of a third aluminum oxide powder (manufactured by Showa Denko K.K., AO-502, average particle diameter 0.2 to 0.3 mm) was blended. In a planetary mixer (ACM-5LVT manufactured by AICOHSHA MFG. CO., LTD.), 100 g of the silicone resin component and 500 g of the thermally conductive filler were introduced, then in a mixing process, they were mixed at 150 rpm for 10 minutes at atmospheric pressure and further mixed at 150 rpm for 10 minutes in a reduced-pressure environment of 0.1 MPa, and thereafter, the mixture was degassed under reduced pressure to obtain an uncured thermally conductive silicone composition of Example 1. For this thermally conductive silicone composition, measurement of physical properties and evaluation of effects in (1) to (5) mentioned above were carried out.

### Example 2

An uncured thermally conductive silicone composition of Example 2 was obtained in the same manner as in Example 1, except that the A liquid and the B liquid of the two-component addition reaction type silicone gel (I) used in Example 1 were blended at a weight ratio of 48:52 to prepare a silicone resin component. For this thermally conductive silicone composition, measurement of physical properties and evaluation of effects in (1) to (5) mentioned above were carried out. Moreover, when measurement of (6) Consistency after curing mentioned above was carried out for this silicone resin component, the consistency was 20.9.

### Example 3

An uncured thermally conductive silicone composition of Example 3 was obtained in the same manner as in Example 1, except that the A liquid and the B liquid of the two-component addition reaction type silicone gel (I) used in Example 1 were blended at a weight ratio of 60:40 to prepare a silicone resin component. For this thermally conductive silicone composition, measurement of physical properties and evaluation of effects in (1) to (5) mentioned above were carried out. Moreover, when measurement of (6) Consistency after curing mentioned above was carried out for this silicone resin component, the consistency was 106.4.

### Example 4

An uncured thermally conductive silicone composition of Example 4 was obtained in the same manner as in Example 1, except that the blending quantities for the thermally conductive filler (C) used in Example 1 were changed to prepare 200 g of an aluminum oxide powder of three-component system consisting of 120 g of a first aluminum oxide powder, 60 g of a second aluminum oxide powder, and 20 g of a third aluminum oxide powder. For this thermally conductive silicone composition, measurement of physical properties and evaluation of effects in (1) to (5) mentioned above were carried out.

### Example 5

An uncured thermally conductive silicone composition of Example 5 was obtained in the same manner as in Example 1, except that the blending quantities for the thermally conductive filler (C) used in Example 1 were changed to prepare 1200 g of an aluminum oxide powder of three-component system consisting of 720 g of a first aluminum oxide powder, 360 g of a second aluminum oxide powder, and 120 g of a third aluminum oxide powder. For this thermally conductive silicone composition, measurement of physical properties and evaluation of effects in (1) to (5) mentioned above were carried out.

### Example 6

An uncured thermally conductive silicone composition of Example 6 was obtained in the same manner as in Example 1, except that the blending quantities for the thermally conductive filler (C) used in Example 1 were changed to prepare 1500 g of an aluminum oxide powder of three-component system consisting of 900 g of a first aluminum oxide powder, 450 g of a second aluminum oxide powder, and 150 g of a third aluminum oxide powder. For this thermally conductive silicone composition, measurement of physical properties and evaluation of effects in (1) to (5) mentioned above were carried out.

### Example 7

An uncured thermally conductive silicone composition of Example 7 was obtained in the same manner as in Example 1, except that 0.1 g of iron oxide (manufactured by TODA KOGYO CORP., 120ED) was further added as a heat stabilizer (E) in the mixing process. For this thermally conductive silicone composition, measurement of physical properties and evaluation of effects in (1) to (5) mentioned above were carried out.

### Example 8

An uncured thermally conductive silicone composition of Example 8 was obtained in the same manner as in Example 7, except that the addition amount of iron oxide as the heat stabilizer (E) used in Example 7 was changed to 5 g. For this thermally conductive silicone composition, measurement of physical properties and evaluation of effects in (1) to (5) mentioned above were carried out.

### Example 9

An uncured thermally conductive silicone composition of Example 9 was obtained in the same manner as in Example 7, except that the addition amount of iron oxide as the heat stabilizer (E) used in Example 7 was changed to 10 g. For this thermally conductive silicone composition, measurement of physical properties and evaluation of effects in (1) to (5) mentioned above were carried out.

### Example 10

An uncured thermally conductive silicone composition of Example 10 was obtained in the same manner as in Example 7, except that the addition amount of iron oxide as the heat stabilizer (E) used in Example 7 was changed to 20 g. For this thermally conductive silicone composition, measurement of physical properties and evaluation of effects in (1) to (5) mentioned above were carried out.

### Example 11

An uncured thermally conductive silicone composition of Example 11 was obtained in the same manner as in Example 7, except that the heat stabilizer (E) was changed to 0.1 g of carbon (TOKABLACK #3800 manufactured by TOKAI CARBON CO., LTD.). For this thermally conductive silicone composition, measurement of physical properties and evaluation of effects in (1) to (5) mentioned above were carried out.

### Example 12

An uncured thermally conductive silicone composition of Example 12 was obtained in the same manner as in Example 11, except that the addition amount of carbon as the heat stabilizer (E) used in Example 11 was changed to 5 g. For this thermally conductive silicone composition, measurement of physical properties and evaluation of effects in (1) to (5) mentioned above were carried out.

### Example 13

An uncured thermally conductive silicone composition of Example 13 was obtained in the same manner as in Example 11, except that the addition amount of carbon as the heat stabilizer (E) used in Example 11 was changed to 10 g. For this thermally conductive silicone composition, measurement of physical properties and evaluation of effects in (1) to (5) mentioned above were carried out.

### Example 14

An uncured thermally conductive silicone composition of Example 14 was obtained in the same manner as in Example 11, except that the addition amount of carbon as the heat stabilizer (E) used in Example 11 was changed to 20 g. For this thermally conductive silicone composition, measurement of physical properties and evaluation of effects in (1) to (5) mentioned above were carried out.

### Example 15

An uncured thermally conductive silicone composition of Example 15 was obtained in the same manner as in Example 13, except that the A liquid and the B liquid of the two-component addition reaction type silicone gel (I) used in Example 13 were blended at a weight ratio of 61:39 to prepare a silicone resin component. For this thermally conductive silicone composition, measurement of physical properties and evaluation of effects in (1) to (5) mentioned above were carried out. Moreover, when measurement of (6) Consistency after curing mentioned above was carried out for this silicone resin component, the consistency was 125.

### Example 16

Using a two-component addition reaction type silicone gel (II) (KE1063 manufactured by Shin-Etsu Chemical Co., Ltd.) as a silicone resin component, A liquid in which a phenyl-modified organopolysiloxane having vinyl groups at both ends as an organopolysiloxane (A) component and a hydrosilylation catalyst (D) had been mixed, and B liquid in which the organopolysiloxane (A) component and a phenyl-modified organohydrogenpolysiloxane as an organohydrogenpolysiloxane (B) component had been mixed were blended at a weight ratio of 50:50 to prepare 100 g of a silicone resin component. When measurement of (6) Consistency after curing mentioned above was carried out for this silicone resin component, the consistency was 64.8. Furthermore, an uncured thermally conductive silicone composition of Example 16 was obtained in the same manner as in Example 1, except that 10 g of carbon (TOKABLACK #3800 manufactured by TOKAI CARBON CO., LTD.) was added as a heat stabilizer (E). For this thermally conductive silicone composition, measurement of physical properties and evaluation of effects in (1) to (5) mentioned above were carried out.

### Comparative Example 1

An uncured thermally conductive silicone composition of Comparative Example 1 was obtained in the same manner as in Example 1, except that the blending quantities for the thermally conductive filler (C) used in Example 1 were changed to prepare 100 g of an aluminum oxide powder of three-component system consisting of 60 g of a first aluminum oxide powder, 30 g of a second aluminum oxide powder, and 10 g of a third aluminum oxide powder, and that 10 g of carbon (TOKABLACK #3800 manufactured by TOKAI CARBON CO., LTD.) was added as a heat stabilizer (E). For this thermally conductive silicone composition, measurement of physical properties and evaluation of effects in (1) to (5) mentioned above were carried out.

### Comparative Example 2

An uncured thermally conductive silicone composition of Comparative Example 2 was obtained in the same manner as in Comparative Example 1, except that the blending quantities for the thermally conductive filler (C) used in Comparative Example 1 were changed to prepare 2000 g of an aluminum oxide powder of three-component system consisting of 1200 g of a first aluminum oxide powder, 600 g of a second aluminum oxide powder, and 200 g of a third aluminum oxide powder. For this thermally conductive silicone composition, measurement of physical properties and evaluation of effects in (1) to (5) mentioned above were carried out.

### Comparative Example 3

For the silicone resin component according to the present Comparative Example, A liquid of the two-component addition reaction type silicone gel (I) (SEMICOSIL (registered trademark) 920LT manufactured by Wacker Asahikasei Silicone Co., Ltd.) used in Example 1 and B liquid of a two-component addition reaction type silicone gel (III) (CF5106 manufactured by Dow Corning Toray Co., Ltd.) were used. In the B liquid of the two-component addition reaction type silicone gel (III), an organohydrogenpolysiloxane that did not have a phenyl group in a molecule and was not modified with phenyl and organopolysiloxane that did not have a phenyl group in a molecule and was not modified with phenyl were mixed. The A liquid of the two-component addition reaction type silicone gel (I) used in Example 1 and the B liquid of this two-component addition reaction type silicone gel (III) were blended at a weight ratio of 50:50 to prepare 100 g of a silicone resin component. When measurement of (6) Consistency after curing mentioned above was carried out for this silicone resin component, the consistency was 46.6. Then, an uncured thermally conductive silicone composition of Comparative Example 3 was obtained in the same manner as in Example 1, except that 10 g of carbon (TOKABLACK #3800 manufactured by TOKAI CARBON CO., LTD.) was added as a heat stabilizer (E). For this thermally conductive silicone composition, measurement of physical properties and evaluation of effects in (1) to (5) mentioned above were carried out.

### Comparative Example 4

For the silicone resin component according to the present Comparative Example, A liquid and B liquid of the two-component addition reaction type silicone gel (III) (CF5106 manufactured by Dow Corning Toray Co., Ltd.) used in Comparative Example 3 were used. In the A liquid of this two-component addition reaction type silicone gel (III), an organopolysiloxane component having vinyl groups at both ends and a hydrosilylation catalyst (D) were mixed, but this organopolysiloxane component was the same component as the organopolysiloxane component contained in the B liquid and was an organopolysiloxane that did not have a phenyl group in a molecule and was not modified with phenyl. Therefore, neither the organopolysiloxane nor the organohydrogenpolysiloxane contained in the A liquid and/or the B liquid had a phenyl group in a molecule and were modified with phenyl. The A liquid and the B liquid of this two-component addition reaction type silicone gel (III) were blended at a weight ratio of 50:50 to prepare 100 g of a silicone resin component. When measurement of (6) Consistency after curing mentioned above was carried out for this silicone resin component, the consistency was 44.3. Then, an uncured thermally conductive silicone composition of Comparative Example 4 was obtained in the same manner as in Example 1, except that 10 g of carbon (TOKABLACK #3800 manufactured by TOKAI CARBON CO., LTD.) was added as a heat stabilizer (E). For this thermally conductive silicone composition, measurement of physical properties and evaluation of effects in (1) to (5) mentioned above were carried out.

The results of Examples 1 to 6, the results of Examples 7 to 10, and the results of Examples 11 to 16 are set forth in Table 1, Table 2, and Table 3, respectively.

TABLE 1

| | | | Example 1 | Example 2 | Example 3 | Example 4 | Example 5 | Example 6 |
|---|---|---|---|---|---|---|---|---|
| Constitution | Silicone resin component, | | (I) | (I) | (I) | (I) | (I) | (I) |
| | Material applied | | | | | | | |
| | A liquid | Blending [g] | 55 | 48 | 60 | 55 | 55 | 55 |
| | B liquid | Blending [g] | 45 | 52 | 40 | 45 | 45 | 45 |
| | Silicone resin component, | | 100 | 100 | 100 | 100 | 100 | 100 |
| | Total (g) | | | | | | | |
| | Consistency of cured product of | | 58.9 | 20.9 | 106.4 | 58.9 | 58.9 | 58.9 |
| | silicone resin component | | | | | | | |
| | Component | Material | Al₂O₃ | Al₂O₃ | Al₂O₃ | Al₂O₃ | Al₂O₃ | Al₂O₃ |
| | (C) | Blending [g] | 500 | 500 | 500 | 200 | 1200 | 1500 |
| | Component | Material | — | — | — | — | — | — |
| | (E) | Blending [g] | 0 | 0 | 0 | 0 | 0 | 0 |
| Measured | Thermal | [W/m · K] | 1.5 | 1.5 | 1.2 | 0.8 | 3.2 | 4.5 |
| value | conductivity | | | | | | | |

| | | | | | | | |
|---|---|---|---|---|---|---|---|
| | Hardness (ordinary | 6.9 | 28.1 | 1.0 | 1.0 | 26.2 | 26.9 |
| | temperature): H0 | | | | | | |
| | Hardness (after vacuum heat | 12.8 | 26.7 | 1.0 | 3.0 | 39.3 | 62.6 |
| | treatment): H1 | | | | | | |
| | Amount of hardness change: | 5.9 | −1.4 | 0.0 | 2.0 | 13.1 | 35.7 |
| | H1 − H0 | | | | | | |
| | Hardness change ratio: (H1 − | 86% | −5% | — | — | 50% | 133% |
| | H0)/H0 | | | | | | |
| | Change ratio of complex elastic | 418% | 396% | 337% | 349% | 565% | 596% |
| | modulus G* | | | | | | |
| | Oil bleed [mm] | 0.24 | 0.09 | 0.38 | 0.22 | 0.07 | 0.07 |
| Judgement | Thermal conductive properties | Good | Good | Good | Good | Good | Good |
| | Ordinary temperature flexibility | Good | Good | Good | Good | Good | Good |
| | Plasma environmental | Good | Excellent | Excellent | Excellent | Good | Fair |
| | degradation resistance | | | | | | |
| | Low-temperature flexibility | Excellent | Excellent | Excellent | Excellent | Good | Good |

TABLE 2

| | | | Example 7 | Example 8 | Example 9 | Example 10 |
|---|---|---|---|---|---|---|
| Constitution | Silicone resin component, | | (I) | (I) | (I) | (I) |
| | Material applied | | | | | |
| | A liquid | Blending [g] | 55 | 55 | 55 | 55 |
| | B liquid | Blending [g] | 45 | 45 | 45 | 45 |
| | Silicone resin component, Total (g) | | 100 | 100 | 100 | 100 |
| | Consistency of cured product of | | 58.9 | 58.9 | 58.9 | 58.9 |
| | silicone resin component | | | | | |
| | Component (C) | Material | Al₂O₃ | Al₂O₃ | Al₂O₃ | Al₂O₃ |
| | | Blending [g] | 500 | 500 | 500 | 500 |
| | Component (E) | Material | Fe₂O₃ | Fe₂O₃ | Fe₂O₃ | Fe₂O₃ |
| | | Blending [g] | 0.1 | 5 | 10 | 20 |
| Measured | Thermal | [W/m · K] | 1.7 | 1.7 | 1.7 | 1.8 |
| value | conductivity | | | | | |

| | | | | | |
|---|---|---|---|---|---|
| | Hardness (ordinary temperature): H0 | 11.6 | 20.1 | 20.5 | 21.1 |
| | Hardness (after vacuum heat | 16.2 | 24.1 | 24.5 | 29.1 |
| | treatment): H1 | | | | |
| | Amount of hardness change: H1 − H0 | 4.6 | 4.0 | 4.0 | 8.0 |
| | Hardness change ratio: (H1 − H0)/H0 | 40% | 20% | 20% | 38% |
| | Change ratio of complex elastic | 371% | 346% | 408% | 338% |
| | modulus G* | | | | |
| | Oil bleed [mm] | 0.07 | 0.08 | 0.08 | 0.18 |
| Judgement | Thermal conductive properties | Good | Good | Good | Good |
| | Ordinary temperature flexibility | Good | Good | Good | Good |
| | Plasma environmental | Excellent | Excellent | Good | Good |
| | degradation resistance | | | | |
| | Low-temperature flexibility | Excellent | Excellent | Excellent | Excellent |

TABLE 3

| | | | Exam- | Exam- | Exam- | Exam- | Exam- | Exam- |
|---|---|---|---|---|---|---|---|---|
| | | | ple 11 | ple 12 | ple 13 | ple 14 | ple 15 | ple 16 |
| Constitution | Silicone resin component, | | (I) | (I) | (I) | (I) | (I) | (II) |
| | Material applied | | | | | | | |
| | A liquid | Blending [g] | 55 | 55 | 55 | 55 | 61 | 50 |
| | B liquid | Blending [g] | 45 | 45 | 45 | 45 | 39 | 50 |
| | Silicone resin component, | | 100 | 100 | 100 | 100 | 100 | 100 |
| | Total (g) | | | | | | | |
| | Consistency of cured | | 58.9 | 58.9 | 58.9 | 58.9 | 125 | 64.8 |
| | product of silicone resin | | | | | | | |
| | component | | | | | | | |
| | Component | Material | Al₂O₃ | Al₂O₃ | Al₂O₃ | Al₂O₃ | Al₂O₃ | Al₂O₃ |
| | (C) | Blending [g] | 500 | 500 | 500 | 500 | 500 | 500 |
| | Component | Material | Carbon | Carbon | Carbon | Carbon | Carbon | Carbon |
| | (E) | Blending [g] | 0.1 | 5 | 10 | 20 | 10 | 10 |
| Measured | Thermal | [W/m · K] | 1.5 | 1.7 | 2.1 | 1.6 | 1.2 | 1.6 |
| value | conductivity | | | | | | | |

| | | | | | | | |
|---|---|---|---|---|---|---|---|
| | Hardness (ordinary | 7.2 | 21.3 | 22.0 | 19.9 | 1.0 | 6.0 |
| | temperature): H0 | | | | | | |
| | Hardness (after vacuum | 12.0 | 24.0 | 24.7 | 26.4 | 1.0 | 10.5 |
| | heat treatment): H1 | | | | | | |
| | Amount of hardness | 4.8 | 2.7 | 2.7 | 6.5 | 0.0 | 4.5 |
| | change: H1 − H0 | | | | | | |
| | Hardness change ratio: | 67% | 13% | 12% | 33% | — | 75% |
| | (H1 − H0)/H0 | | | | | | |
| | Change ratio of complex | 456% | 442% | 355% | 462% | 320% | 326% |
| | elastic modulus G* | | | | | | |
| | Oil bleed [mm] | 0.10 | 0.08 | 0.05 | 0.15 | 0.30 | 0.09 |
| Judgement | Thermal conductive | Good | Good | Good | Good | Good | Good |
| | properties | | | | | | |
| | Ordinary temperature | Good | Good | Good | Good | Good | Good |
| | flexibility | | | | | | |
| | Plasma environmental | Excellent | Excellent | Good | Good | Excellent | Excellent |
| | degradation resistance | | | | | | |
| | Low-temperature flexibility | Excellent | Excellent | Excellent | Excellent | Excellent | Excellent |

The results of Comparative Examples 1 to 4 are set forth in Table 4.

TABLE 4

| | | | Comparative | Comparative | Comparative | Comparative |
|---|---|---|---|---|---|---|
| | | | Example 1 | Example 2 | Example 3 | Example 4 |
| Constitution | Silicone resin component, | | (I) | (I) | (I) | (III) |
| | Material applied to A liquid | | | | | |
| | Silicone resin component, | | (I) | (I) | (III) | (III) |
| | Material applied to B liquid | | | | | |
| | A liquid | Blending [g] | 55 | 55 | 50 | 50 |
| | B liquid | Blending [g] | 45 | 45 | 50 | 50 |
| | Silicone resin component, | | 100 | 100 | 100 | 100 |
| | Total (g) | | | | | |
| | Consistency of cured product of | | 58.9 | 58.9 | 46.6 | 44.3 |
| | silicone resin component | | | | | |
| | Component (C) | Component | Al₂O₃ | Al₂O₃ | Al₂O₃ | Al₂O₃ |
| | | Blending | 100 | 2000 | 500 | 500 |
| | Component (E) | Component | Carbon | Carbon | Carbon | Carbon |
| | | Blending | 10 | 10 | 10 | 10 |
| Measured | Thermal | [W/m · K] | 0.45 | 5.6 | 1.8 | 1.5 |
| value | conductivity | | | | | |

| | | | | | |
|---|---|---|---|---|---|
| | Hardness (ordinary temperature): | 1.0 | 32.9 | 25.2 | 7.5 |
| | H0 | | | | |
| | Hardness (after vacuum heat | 1.0 | 74.8 | 29.0 | 6.4 |
| | treatment): H1 | | | | |
| | Amount of hardness change: H1 − | 0.0 | 41.9 | 3.8 | −1.1 |
| | H0 | | | | |
| | Hardness change ratio: (H1 − | — | 127% | 15% | −15% |
| | H0)/H0 | | | | |
| | Change ratio of complex elastic | 397% | 704% | 2898% | 792% |
| | modulus G* | | | | |
| | Oil bleed [mm] | 0.15 | 0.08 | 0.13 | 0.25 |
| Judgement | Thermal conductive properties | Poor | Good | Good | Good |
| | Ordinary temperature flexibility | Good | Good | Good | Good |
| | Plasma environmental | Excellent | Poor | Good | Good |
| | degradation resistance | | | | |
| | Low-temperature flexibility | Excellent | Poor | Poor | Poor |

From the results of Examples 1 to 16 in Table 1 to Table 3, it can be seen that the thermally conductive silicon composition having the constitution of the present invention had physical properties: a hardness of the cured product was 70 or less in terms of Asker C hardness, a hardness of the cured product after being heated for 24 hours in an environment of a vacuum degree of 500 Pa (absolute pressure) and 200° C. was 70 or less in terms of Asker C hardness, a thermal conductivity was 0.5 W/m·K or more, and a low-temperature change ratio of a complex elastic modulus, as determined by dividing an absolute value of a difference between a complex elastic modulus of the cured product at 20° C. and a complex elastic modulus thereof at −60° C. by a complex elastic modulus of the cured product at 20° C., was 700% or less, and therefore, the cured product had both flexibility at low temperatures and plasma environmental degradation resistance. Moreover, from the results of Example 16, it can be seen that even though the materials of the silicone resin component were changed, the same results were obtained as long as both the organopolysiloxane (A) and the organohydrogenpolysiloxane (B) were modified with phenyl.

The thermally conductive silicone composition of Example 15, in which a hardness of the silicone resin component after crosslinking reaction was 125 in terms of consistency, was cured, but its cured product had lower shape retention properties than other Examples, though this is not described in Table 3, and from this, it can be seen that the hardness of the silicone resin component after crosslinking reaction is preferably 110 or less in terms of consistency.

From comparison between the results of Example 1 and the results of Examples 7 to 14, it can be seen that by blending a heat stabilizer (E) of a metal oxide such as iron oxide or a carbon-based heat stabilizer, which had radical trapping properties, a hardness change ratio of the cured product after vacuum heat treatment was able to be decreased, and plasma environmental degradation resistance was improved. Moreover, it can be seen that an oil bleed reduction effect after curing was also obtained. Regarding these effects due to the addition of the heat stabilizer (E), it can be seen that by adding 0.1 to 20 parts by weight of the heat stabilizer (E) based on 100 parts by weight of the silicone resin component, sufficient effects were obtained, and in the addition range of 0.1 to 5 parts by weight, the effects were particularly excellent.

On the other hand, from the results of Comparative Examples 1 to 4 shown in Table 4, it can be seen that the thermally conductive silicone compositions not having the constitution of the present invention were unable to obtain the effects of the present invention. Specifically, the results of Comparative Example 1 reveal that when the blending quantity of the thermally conductive filler (C) was set to less than 200 parts by weight based on 100 parts by weight of the silicone resin component, the cured product did not have sufficient thermal conductive properties. As in Comparative Example 2, when the blending quantity of the thermally conductive filler (C) exceeded the range of 1500 parts by weight, plasma environmental degradation resistance and low-temperature flexibility of the cure product were insufficient. As in Comparative Examples 3 and 4, when at least one of the organopolysiloxane (A) and the organohydrogenpolysiloxane (B) constituting the addition reaction type silicone resin component did not have a phenyl group and was not a phenyl-modified compound, low-temperature flexibility of the cured product was markedly decreased, and therefore, it has been confirmed that including a phenyl group in a molecule both in the (A) component and the (B) component constituting the silicone resin component is important in the present invention.

### INDUSTRIAL APPLICABILITY

The thermally conductive silicone composition of the present invention has both flexibility at low temperatures and plasma environmental degradation resistance after curing, and therefore, when a cured product thereof is utilized as a thermally conductive member for a semiconductor etching apparatus, temperature rise of a focus ring can be suppressed stably over time, and semiconductor etching processing can be stably carried out, even if high-powered plasm is used in the semiconductor etching processing.

### REFERENCE SIGNS LIST

1 substrate mounting unit
2 mounting table (lower electrode unit)
2a chuck mechanism section (wafer chuck, or the like)
2b support table
3 focus ring (edge ring)
4 cooling unit
5 thermally conductive member
W substrate to be treated (wafer, or the like)

1-7. (canceled)

8. A thermally conductive silicone composition comprising a silicone resin component and a thermally conductive filler (C), the silicone resin component comprising an organopolysiloxane (A) having alkenyl groups at least at both ends, an organohydrogenpolysiloxane (B) having at least one hydrogen atom bonded to a silicon atom in one molecule, and a hydrosilylation catalyst (D), wherein
the organopolysiloxane (A) is a phenyl-modified organopolysiloxane having at least one phenyl group in a molecule,
the organohydrogenpolysiloxane (B) is a phenyl-modified organohydrogenpolysiloxane having at least one phenyl group in a molecule,
a blending ratio of the thermally conductive filler (C) is 200 to 1500 parts by weight based on 100 parts by weight of the silicone resin component,
a hardness of a cured product of the thermally conductive silicone composition is 70 or less in terms of Asker C hardness (in accordance with JIS K6249), and a hardness of the cured product, after being heated in an environment of a vacuum degree of 500 Pa (absolute pressure) and 200° C. for 24 hours, is 70 or less in terms of Asker C hardness (in accordance with JIS K6249),
a thermal conductivity of the cured product is 0.5 W/m·K or more, and
a low-temperature change ratio of a complex elastic modulus, as determined by dividing an absolute value of a difference between a complex elastic modulus of the cured product at 20° C. and a complex elastic modulus thereof at −60° C. by a complex elastic modulus of the cured product at 20° C., is 700% or less.

9. The thermally conductive silicone composition according to claim 8, wherein a hardness of the silicone resin component after crosslinking reaction is 110 or less in terms of consistency (in accordance with JIS K2220 ¼ cone).

10. The thermally conductive silicone composition according to claim 8, further comprising a heat stabilizer (E).

11. The thermally conductive silicone composition according to claim 10, wherein a blending ratio of the heat stabilizer (E) is 0.1 to 20 parts by weight based on 100 parts by weight of the silicone resin component.

12. The thermally conductive silicone composition according to claim 10, wherein the heat stabilizer (E) is a metal oxide or a carbon-based heat stabilizer, which has radical trapping properties.

13. The thermally conductive silicone composition according to claim 11, wherein the heat stabilizer (E) is a metal oxide or a carbon-based heat stabilizer, which has radical trapping properties.

14. A thermally conductive member comprising a cured product of the thermally conductive silicone composition according to claim 8.

15. A thermally conductive member comprising a cured product of the thermally conductive silicone composition according to claim 10.

16. A thermally conductive member for a semiconductor etching apparatus, comprising a cured product of the thermally conductive silicone composition according to claim 8.

17. A thermally conductive member for a semiconductor etching apparatus, comprising a cured product of the thermally conductive silicone composition according to claim 10.
